(19) United States
(12) Patent Application Publication
(10) Pub. No.: US 2012/0324025 A1
(43) Pub. Date: Dec. 20, 2012

(54) REAL TIME URL UNIFICATION, SCORING, AND MARKETING AUTOMATION

(76) Inventor: John G. Adams, III, Saratoga, CA (US)

(21) Appl. No.: 13/523,642

(22) Filed: Jun. 14, 2012

Related U.S. Application Data
(60) Provisional application No. 61/496,920, filed on Jun. 14, 2011.

(51) Int. Cl. G06F 15/16

(52) U.S. Cl. 709/206

(57) ABSTRACT

Systems and methods for analyzing link name page visits are disclosed herein. According to one embodiment, one or more computer readable storage media encoded with instructions executable by one or more processing units of a computing system is disclosed. The instructions may comprise instructions for determining if logged data satisfies a first set of criteria, storing an entry indicative of the logged data and a page type, updating a lead score corresponding to the logged data, determining if the logged data satisfies a second set of criteria, and generating an automated mailing signal responsive, at least in part, to determining the visit satisfies the second set of criteria.

### CROSS REFERENCE TO RELATED APPLICATION(S)

This application claims priority to U.S. Provisional Application No. 61/496,920, filed Jun. 14, 2011, which application is incorporated herein by reference in its entirety for any purpose.

### FIELD OF THE INVENTION

The invention relates generally to filtering tools and systems that allow businesses to organize, consolidate and label visitor web log data for the purpose of accurately automating updates to visitors' quality scores and/or automate targeted electronic and direct mail to web site visitors.

### BACKGROUND OF THE INVENTION

Various web visitor tracking services, such as Google Analytics, provide Users with reports on website visit activity to URLs for the purpose of providing web traffic insights to marketers. However, these tools do not provide sufficient filtering mechanisms that organize, consolidate and label visitor activity for the purpose of automating updates to lead quality scores and/or automating marketing communications when visits to the URLs are logged. Without this approach, marketers are unable to reliably use web visit activity to increment visitor quality scores and/or trigger communications with precision and therefore unable to take advantage of cost and productivity efficiencies of sales and marketing automation.

### BRIEF DESCRIPTION OF DRAWINGS

FIG. 1 illustrates an exemplary network diagram system.

FIG. 2 illustrates the process of assigning a Link Name to a web visit and triggering a lead score update action based on a visit to that link name.

FIG. 3 illustrates a flow chart of how the invention is used to setup triggered marketing communications and increment lead scores.

FIG. 4 illustrates a flow chart of how the invention is used to process a visit into a link name and trigger an action.

FIG. 5 illustrates a screen shot diagram demonstrating execution of a workflow automation wizard according to an embodiment of the present invention.

FIG. 6 illustrates a screen shot of where a User may specify that a Link Filter 610 and Link Name 620 may be used to trigger actions

FIG. 7 illustrates a screen shot of where a User may specify a Link Name, Group/Page Type, and Lead Score increment value.

FIG. 8 illustrates a flow diagram according to an embodiment of the present invention.

### DETAILED DESCRIPTION

Embodiments of the invention relate to the positive effects of applying filters to tightly organize and label web visit log data as a necessity to automating communications and incrementing lead and prospect quality scores based visits to User websites.

Real Time URL Unification (RTUU) is the process of automatically combining a multitude of redundant URL instances that occur from web logging into a single easily understood Link Name and assigning them to a category. Redundant URLs commonly occur in web logs due to application of tracking codes or other information appended to linking URL's syntax.

RTUU is achieved with a filtering tool. The work of unifying URLs into a Link Name, Page Type, and quality score is used by a connected Marketing Automation system that allows businesses to automatically send email, direct mail, sales alerts and increment quality scores based on web visit profiles.

Marketing Automation relies heavily on Real Time URL Unification because the redundant instances of URLs that occur in visitor tracking and web logging cause automation execution orders to be missed.

For example, if a Business User wants to automatically trigger a direct mail piece to be sent to a Visitor to “www.mybusiness.com/products”, the trigger will be missed if the Visitor's visit to the page is tracked and logged as “www.mybusiness.com/products&k87”.

With RTUU, the Business User applies a rule that specifies any tracked URL containing “www.mybusiness.com/products” be logged and assigned a Link Name “Products”. What's more, they can categorize Link Names under a Page Type and further specify the quality score of visitors to Page Types be incremented or decremented. The visit activity of that individual is automatically stored to their web activity record.

The capability to assign Link Names and Page Types give the Business Users full assurance that the automation triggers they set, such as sending email, direct mail, sales alerts, and incrementing lead scores when a particular web page is visited, will not be missed. This results in improved business performance. For example, emails that are triggered based on visitor actions can be over 100% more effective than emails that are sent as part of a general non-triggered broadcast. What's more, businesses save on resources when not having to manually compile segmented lists of individuals who meet preferred behavior profiles and broadcast to those lists. With regard to direct mail, Users of this system can automatically order direct mail advertisements to be produced and sent to any qualifying visitor without the expense of minimum print runs and manual labor associated with tracking what visitors should receive the direct mail and processing the individual pieces for mailing.

Example Use Case

Luxury Real Estate, Inc. in New York, N.Y. may wish to send a 12 page color brochure to individuals that visit a web page featuring Luxury Rentals and increase the individual's quality score, for example, by 300 points. The web page is located at the URL www.luxuryrealestate.com/luxuryrentals.

By sending a brochure quickly after a visit to a Luxury Rentals page, Luxury Real Estate may be able to make a positive impression on the individual. And by maintaining a quality score for the individual, Luxury Real Estate may be able to trigger multiple other actions, such as sending an alert to a sales agent and sending an email to the individual requesting an appointment.

Luxury Real Estate may advertise Luxury Rentals it offers by purchasing keywords on Google and affiliate networks. The company tracks which traffic sources work best by providing each source a “tracking code” that is added to the end of linking URLs. The results of applying a tracking codes to linking URLs and having multiple sources of visitor traffic to www.luxuryrealestate.com/luxuryrentals may cause many different instances of the page www.luxuryrealestate.com/luxuryrentals to occur in web logs.

For example, the web visits they see in their logs are www.luxuryrealestate.com/luxuryrentals?pmc=123 and www.luxuryrealestate.com/luxuryrentals?pmc=345.

The consequence may be that Luxury Real Estate's marketing team cannot ensure that all visitors to www.luxuryrealestate.com/luxuryrentals will be sent a brochure because if they set an automation rule to “send brochure to a visitor to www.luxuryrealestate.com/luxuryrentals” a visitor who's visit is logged as www.luxuryrealestate.com/luxuryrentals?pmc=123 may not be recognized as visiting “www.luxuryrealestate.com/luxuryrentals”.

To address this problem the company may access a marketing automation solution that is equipped with the invention via the Internet and applies a Link Filter to apply a Link Name to the page www.luxuryrealestate.com/luxuryrentals. The filter enables allow Luxury Real Estate to assign all visits to that page, regardless of source and URL syntax, to a single Link Name. What's more, they can assign that Link Name to a Page Type and increment quality scores for individuals who visit pages assigned the Page Type.

The Luxury Real Estate User applies a Link Filter that assigns all visits to any page containing “/luxuryrentals” to the Link Name “Luxury Rentals”. And, they use the Link Filter to further specify that a visit to any pages with the Link Name “Luxury Rentals” be categorized as a “High Value” Page Type and that an individual who visits a “High Value” page have their score incremented by 300. The Score increase will bring the score for that individual to greater than 200, which may be a trigger point for sending an automated email to individuals that invite them to tour properties. In addition, the sales agent assigned to the individual may automatically be sent an alert that the tour request email has been sent and instructs him to call the individual.

Positive Commercial Impact of Real Time URL Unification, Scoring, and Marketing Automation

The result of filtering is that all visitors who visit the Luxury Rentals web page will have their visit logged and stored as having visited the Link Name “Luxury Rentals”. Therefore the marketing team is assured any visit that's logged as a permutation of the www.luxuryrealestate.com/luxuryrentals will be associated with the “Luxury Rentals” Link Name and will not be missed by rules specified in their automation.

This in turn assures the marketers that the quality score of the individual visitor will incremented, an email requesting a tour request will be sent, and a brochure will be sent.

Certain details are set forth below to provide a sufficient understanding of embodiments of the invention. However, it will be clear to one having skill in the art that embodiments of the invention may be practiced without these particular details. Moreover, the particular embodiments of the present invention described herein are provided by way of example and should not be used to limit the scope of the invention to these particular embodiments. In other instances, well-known hardware and/or software operations have not been shown in detail in order to avoid unnecessarily obscuring the invention.

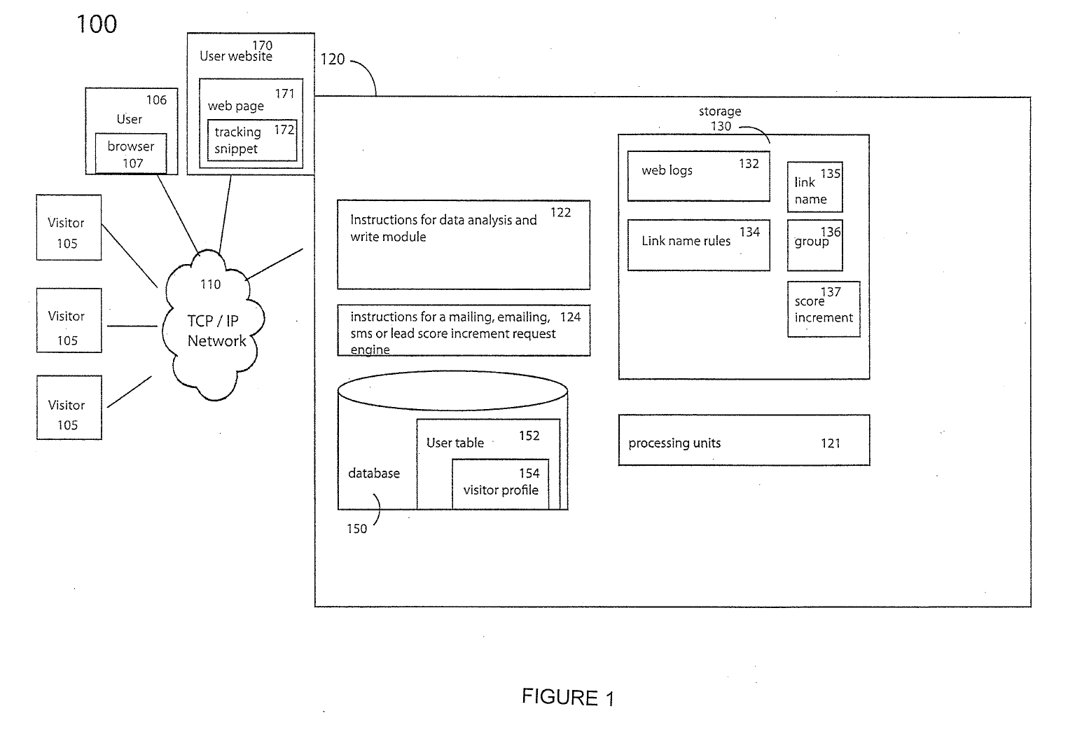

The block diagram of FIG. 1 provides a high level system architecture according to an embodiment of the present invention.

The server 120 may include one or more processing units 121 and computer readable media 130, 150. Herein, the term computer readable media is used to refer to a single computer readable medium in some embodiments, and in other embodiments multiple computer readable media in communication with one or more processing units, such as the one or more processing units 121. The computer readable media 130 may be configured to store executable instructions for a data analysis and write model 121 (hereinafter “write model”) and executable for a mailing, emailing, sms, or lead score increment request engine 124 (hereinafter “request engine”). The executable instructions for a data analysis and write module 121 may include instructions for identifying a visitor, determining what User table 152 and visitor profile 154 to write visit activity data to, and whether identification data corresponding to a visitor meets certain criteria, further examples of which are provided below.

Although the executable instructions for the data analysis and write module 122 and the executable instructions for the mailing, emailing, sms, and lead score increment engine 124 are shown on a same computer readable media 130, in some embodiments any or all sets of instructions may be provided on multiple computer readable media, and may not be resident on the same media. Computer readable media herein may include any form of computer readable storage or computer readable memory, including but not limited to externally or internally attached hard disk drives, solid-state storage (such as NAND flash or NOR flash media), tiered storage solutions, storage area networks, networked attached storage, and/or optical storage.

A User 106 may access the write model by logging into an application executing on the server 120. The User 106 may, for example, access the application through the TCP/IP network 110. In at least one embodiment, the TCP/IP network 110 may comprise the Internet. Moreover, the client may include a graphical user interface, such as a PC running a web browser 107.

Embodiments of the present invention relate to a URL consolidation, organization and labeling functions whereby a User may use the write model to enter and store instructions 134, in order to create a single labeled representation 135, and/or assign a group 136, and/or increment/decrement lead quality score values 137 of multiple redundant URL web log entries 132 stored on computer readable media 130.

When a web visitor 105 visits a User's website 170 and/or web page 171 containing a behavior tracking code 172 through the Internet 110 using a client that may include a graphical user interface such as a PC running a web browser 107, to the write model may log the visit into storage 132, then apply the rules created and/or stored in the write model. The write model may further query stored instructions 134 to analyze, label and write the visit information to the visitors profile 154 in the appropriate User table 152 of the database 150.

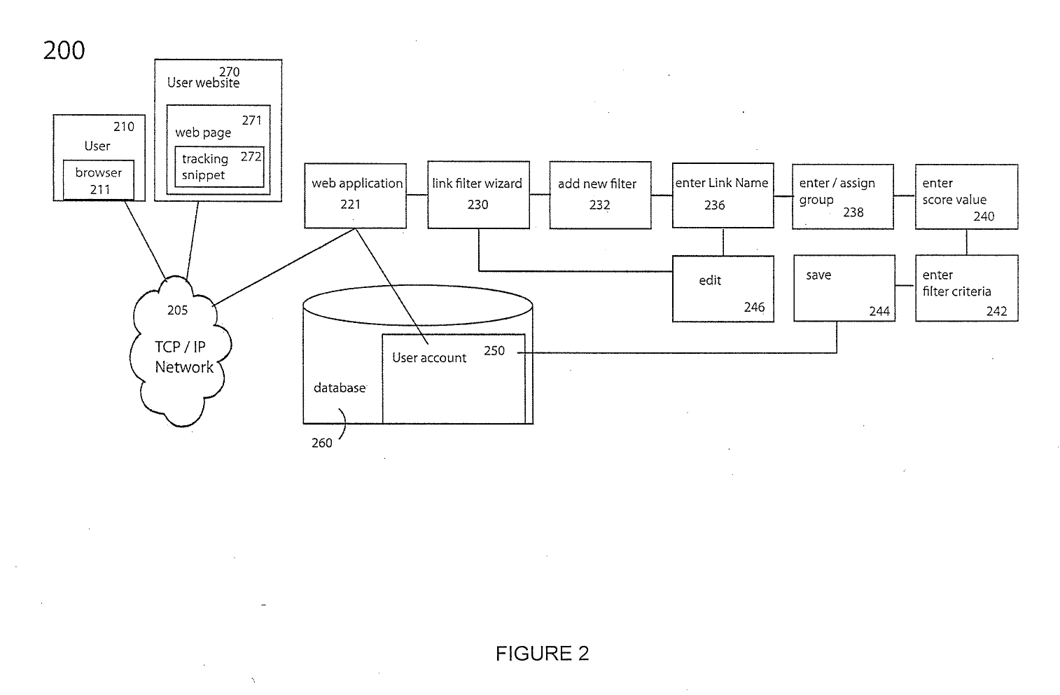

The block diagram 200 of FIG. 2 provides a high-level architecture of an exemplary embodiment of the present disclosure for creating URL unification, normalization and scoring instructions that may, for instance, be used to implement the instructions of 134 and/or 135 and/or 136 and/or 137 of FIG. 1.

The User 210 logs into a web application 221, for example, through the TCP/IP network 205. The client may include a graphical user interface, such as a PC running a web browser 211. The User navigates to a Link Filter Wizard 230 and chooses to add a new filter 232. The web application 221 has the User's login session stored in running memory 260 and will write ensuing instructions to the Users account 250.

The User 210 may then enter text for a Link Name 236, Group 238, Score Value 240, and Filter Criteria 242.

Per the aforementioned example, if the User 210 wanted to consolidate and label web log visits to a Luxury Rental web page 271 on his website 270 and containing a web tracking snippet 272, the user 210 would enter Link Name 236 “Luxury Real Estate” then assign a visit to that Link Name to a Group 238 “High Value Visit” apply a Lead Score Value 240 of “500” and then set Filter Criteria 242 to be “any URL” “containing” “luxury rentals”. The User 210 may click a save link 244 and the criteria set in the Link Filter Wizard 230 is written into storage 250.

If the User 210 wishes to edit the setting created in the Link Filter Wizard 230, he may do so by clicking a Link Name 236 that is displayed and choose to Edit 246. This enables the User 210 to modify settings 236, 238 240, 242 previously applied. Upon completing the edit, the User 210 clicks a save link to write the new instructions into storage 250.

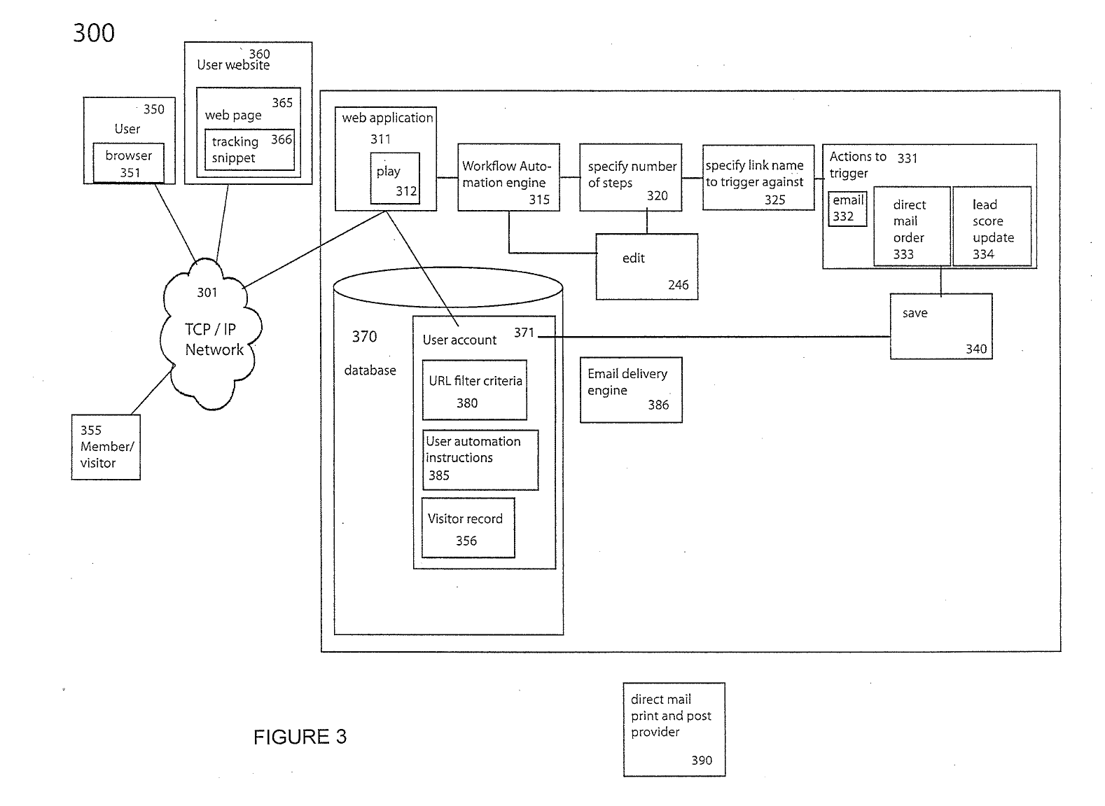

The block diagram of FIG. 3 provides a high-level system architecture for applying URL unification and normalization to automate marketing communication and increment lead scores using a Workflow Automation engine 315.

The User 350 logs into a web application 311 through the TCP/IP network 301. The client may include a graphical user interface, such as a PC running a web browser 351. The User 350 then accesses a Workflow Automation engine 315. The web application 311 has the User's login session stored in running memory 370 and will write ensuing automation instructions for that User's account 371 in on a machine readable drive dedicated to storing the automation instructions 385.

The User 350 may specify the number of action steps in an automation routine 320, and further may specify a link name 325 for when actions, such as sending email from an email delivery engine 386 and/or ordering production and postage of a direct mailing from a print and post partner 390, should be triggered for delivery to a member 355 stored in the Users 350 database 370.

For example, the criteria may be to trigger a Luxury Real Estate direct mail piece to a member 355 who made a web visit through a TCP/IP Network 301 to the User's web page 365 on the User's website 360 and has an assigned link name “Luxury Real Estate” 365.

During the process of creating the automation flow, the User 350 chooses from an assortment of actions 331 to take when link name visit criteria 325 is met. These actions include send email 332 and/or direct mail 333 and/or update lead score 334.

The User 350 will save the workflow 340 and click a “play” icon to activate the Workflow rules and automation.

When a visitor 355 visits a “Luxury Real Estate” page 365 which contains a web tracking snippet 366, the web tracking engine logs the visit and run a query against the URL Filter Criteria 380 that's held in machine readable memory and will write the visit to the visitor's 355 record 356 in the database 370. After the visit is recorded in the visitor's record, the Workflow Automaton engine 315 will query the automation rules 385 to determine if an automated action should be executed against the vistor's 355 web visit activity. If there is a rule to send a direct mail piece 333 to the individual 355 stored in the User automation instructions 385, the system will trigger an order 333 to a print and post vendor 390 to print and post the mail piece. The direct mail order 333 instruction includes contact information of the individual 355, a catalog number to identify which piece to print, and any variable data about the individual 355 that should be printed on the direct mail piece.

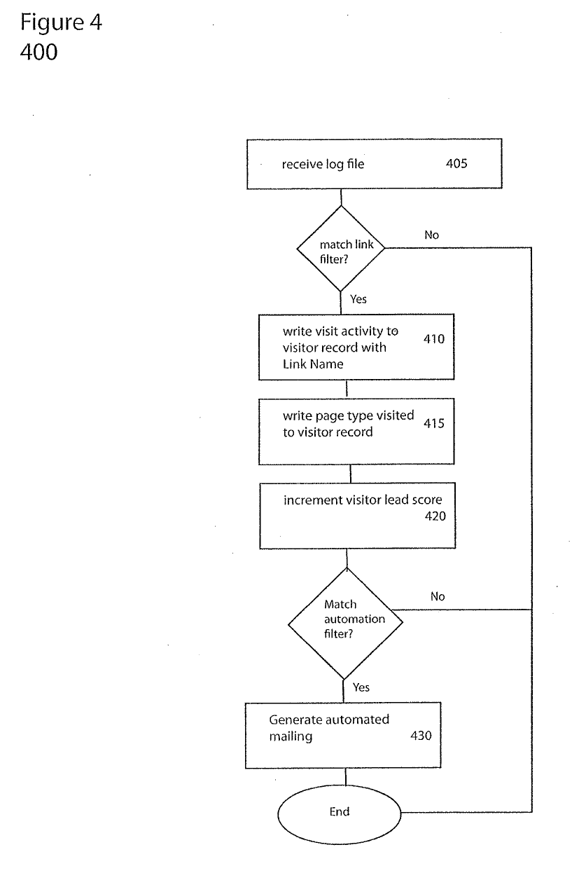

The flow chart diagram 400 in FIG. 4 provides a method for creating URL unification, normalization and scoring instructions and using rules to trigger lead score updates and/or generate automated direct mailings according to an embodiment of the present invention.

The system receives a log file 405 then makes a query to determine if the logged URL matches a link filter rule. If not, the process ends. If there is a match with a link filter rule 410, the system writes the visit activity to that Link Name page to the visitor record 410. The system will also write the page type visited to the visitor's record 415. The system then updates the visitors lead score 420. They system then makes a query to determine if a visit matching that link name is set to trigger an automated mailing 430.

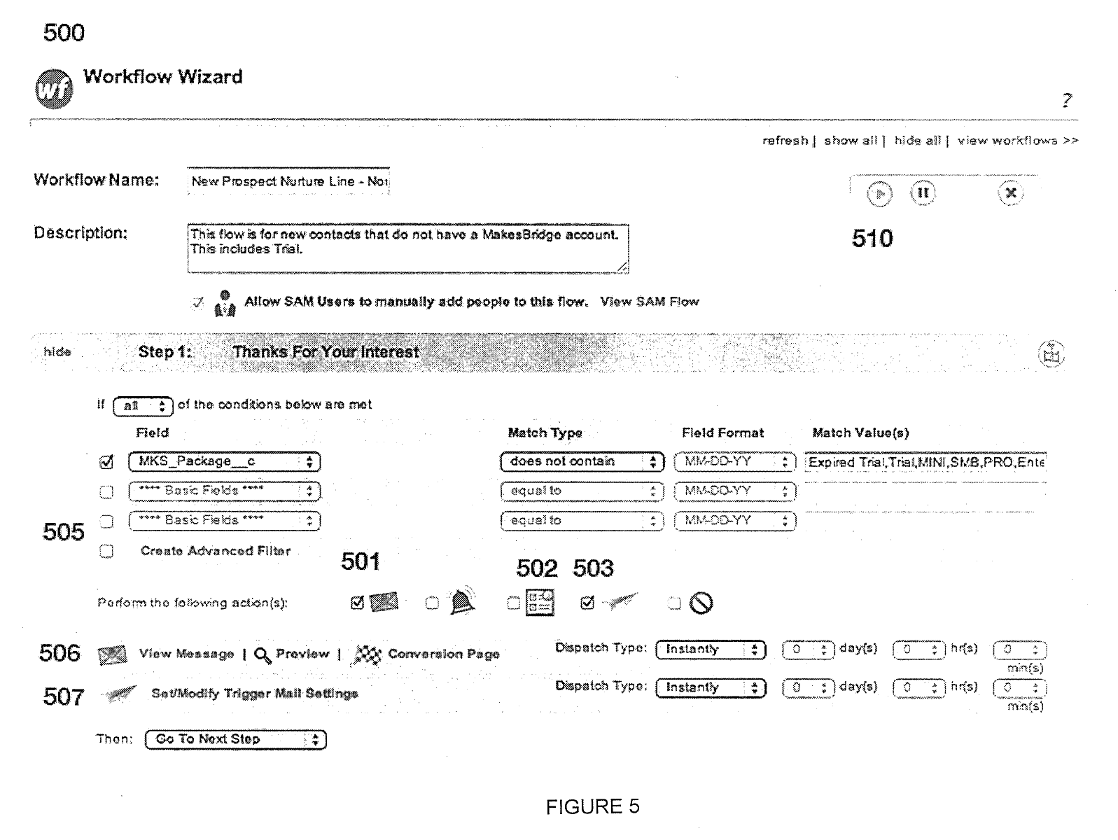

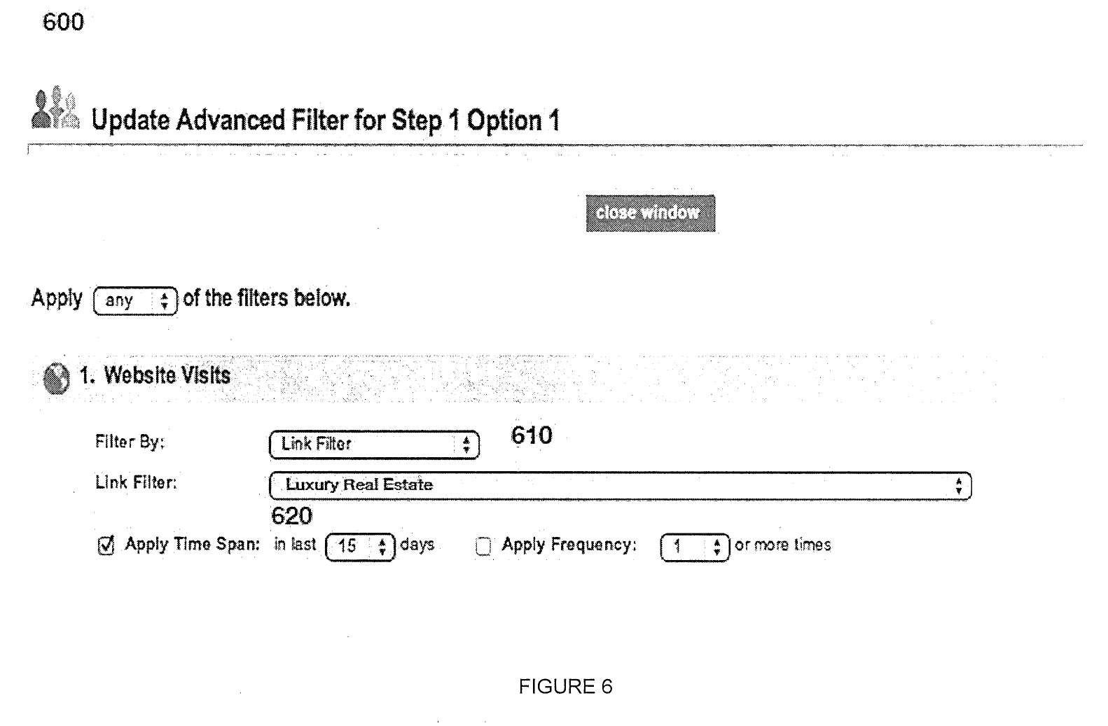

The screen shot diagram 500 shown in FIG. 5 is a screen shot of execution of a workflow automation wizard according to an embodiment of the present invention. Users of the system may choose if they will send email 501 and/or increment lead scores 502 and/or send direct mail 503 when criteria are met. The user can specify when the email action 506 and/or direct mail order 507 will be triggered. The user elects to create and apply an Advanced Filter 505 to specify a link name as provided in diagram 600 in FIG. 6. When the User has completed the workflow setup, he clicks a play button 510 to activate the workflow for ongoing processing of queries with web site visits.

The screen shot diagram 600 shown in FIG. 6 is a screen shot of where a User specifies that a Link Filter 610 and Link Name 620 be used to trigger actions specified in diagram 500 in FIG. 5.

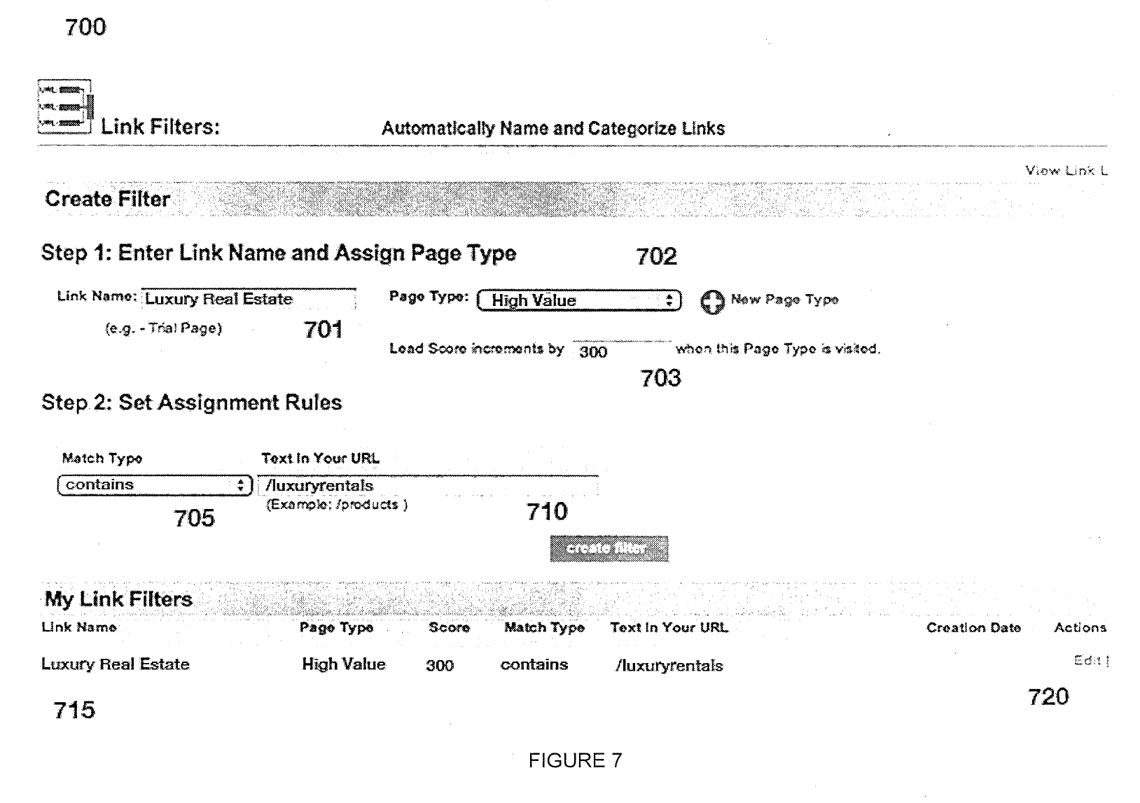

The screen shot diagram 700 in FIG. 7 provides a screen shot of where a User specifies Link Name 701, then Group/Page Type 702, then Lead Score increment value 703. The assignment rules are setup by using a comparison operator/match type 705 that will be used to compare the syntax of the URL written in the web log to the text provided at 710. If the combined setting rule of 705 and 710 are met, then the visit will be labeled according to the instruction in 701, assigned to the group specified at 702, and the lead score of the member/visitor will increment by the value provided 703. A summary of current Link Filters is provided to the User 715 for review and editing 720.

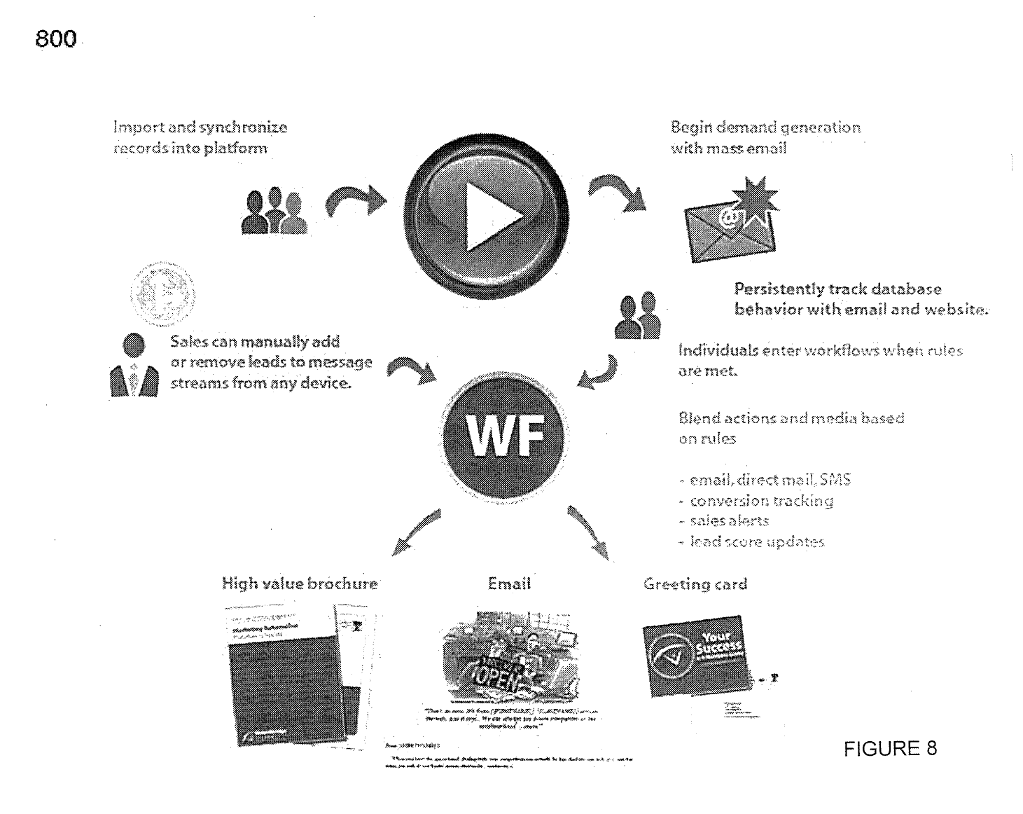

FIG. 8 illustrates a flow diagram 800 according to an embodiment of the present invention. The intention is to provide further context and how embodiments of the invention may be applied in broad marketing context.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. One or more computer readable storage media encoded with instructions executable by one or more processing units of a computing system, the instructions comprising instructions for:
determining if logged data satisfies a first set of criteria;
storing an entry indicative of the logged data and a page type;
updating a lead score corresponding to the logged data;
determining if the logged data satisfies a second set of criteria; and
generating an automated mailing signal responsive, at least in part, to determining the visit satisfies the second set of criteria.

2. The storage media of claim 1, wherein the instructions further comprise instructions for:
providing an automated mailing based, at least in part, on the automated mailing signal.

3. The storage media of claim 1, wherein the first set of criteria comprises a set of link filter rules.

4. The storage media of claim 1, wherein the second set of criteria comprises a set of automation filter rules.

5. The storage media of claim 1, wherein the instructions for said storing an entry comprise instructions for:
storing a visit activity in a visitor record log; and
storing a page type in the visitor record log.

6. The storage media of claim 1, wherein the logged data comprises data corresponding to a link name page access.

7. A method for providing an automated mailing, comprising:
receiving data indicative of a visit to a link name page residing on a server;
determining if the data matches a first set of criteria;
if it is determined that the data matches the first of criteria, storing an entry to a visitor record;
updating a lead score corresponding to the link name page;
determining if the visit to the link name page satisfies a second set of criteria; and
if it is determined that the visit to the link name page satisfies the second set of criteria, generating an automated mailing signal.

8. The method of claim 7, wherein the data comprises URL syntax, and wherein said determining if the data matches comprises:
determining whether the URL syntax matches at least a portion of the link name page using a comparison operator.

9. The method of claim 7, wherein the data indicative of a visit of a link name page comprises a log file.

10. The method of claim 7, wherein the first set of criteria comprises a set of link filter rules and the second set of criteria comprises a set of automated mailing rules.

11. The method of claim 7, further comprising:
logging a visit to the link name page.

12. The method of claim 7, wherein said updating a lead score, comprises:
updating the lead score based, at least in part, on the link name page comprising a high value page type.

13. The method of claim 7, wherein said updating a lead score, comprises:
updating lead score data in a database.

14. The method of claim 7, wherein the automated mailing signal comprises at least one of an e-mail, SMS message, digital signal, analog signal, radio signal, or network communication.

15. The method of claim 7, wherein said determining if the visit to the link name page satisfies a second set of criteria, comprises:
determining if the updated lead score exceeds a predetermined threshold.

16. A system comprising at least one processing unit coupled to a memory, wherein the memory is encoded with computer executable instructions that, when executed, cause the at least one processing unit to:
determine if a visit to a link name page satisfies link name criteria;
update a lead score based, at least in part, on the visit;
determine if the visit satisfies automated mailing criteria; and
generate an automated mailing signal responsive, at least in part, to determining the visit satisfies automated mailing criteria.

17. The system of claim 16, wherein the instructions further cause the at least one processing unit to:
log a visit to the link name page in at least one of a log file or a database.

18. The system of claim 16, wherein the automated mailing criteria is based, at least in part, on a frequency of visits to respective link name pages.

19. The system of claim 16, wherein said determining if a visit to a link name page satisfies link name criteria includes performing URL unification.

20. The system of claim 16, wherein the computer executable instructions further case the at least one processing unit to:
execute an application configured to update at least one of the link name criteria or automated mailing criteria.

21. The system of claim 20, wherein the application is configured to interface with a web browser of a user.
